(19) United States
(12) Patent Application Publication
(10) Pub. No.: US 2015/0324764 A1
(43) Pub. Date: Nov. 12, 2015

(54) Enabling a User to Transact Using Cryptocurrency

(71) Applicant: STELLENBOSCH UNIVERSITY, Stellenbosch (ZA)

(72) Inventors: Gert-Jan VAN ROOYEN, Somerset West (ZA); Herman Arnold ENGELBRECHT, Somerset West (ZA); Helghardt AVENANT, Bellville (ZA); Michail BRYNARD, Durbanville (ZA)

(73) Assignee: STELLENBOSCH UNIVERSITY, Stellenbosch (ZA)

(21) Appl. No.: 14/705,556

(22) Filed: May 6, 2015

(30) Foreign Application Priority Data
May 9, 2014 (ZA) 2014/03311

(51) Int. Cl. G06Q 20/06; G06Q 20/36

(52) U.S. Cl. CPC G06Q 20/065; G06Q 20/3678

(57) ABSTRACT

A system and method of enabling a user to transact using cryptocurrency of a value defined in relation to a different medium of exchange or financial instrument is provided. In the method, a request to create a voucher having a face value remaining defined in relation to the medium of exchange or financial instrument is received. A voucher having key data being associated with a voucher cryptocurrency address holding a token amount of cryptocurrency included therein is generated. A transaction ledger is monitored to determine whether a redeeming transaction against the voucher address has occurred against a destination cryptocurrency address. Responsive to a redeeming transaction against the voucher address occurring, an additional amount of cryptocurrency is transferred to the destination address. The additional amount of cryptocurrency being calculated such that the sum of the token and additional amounts substantially matches a cryptocurrency equivalent of the face value of the voucher.

### CROSS-REFERENCE TO RELATED APPLICATIONS

This application claims priority to South African provisional patent application number 2014/03311 filed on 9 May 2014, which is incorporated by reference herein.

### FIELD OF THE INVENTION

This invention relates to cryptocurrency transactions. More particularly, the invention relates to a method and system for enabling a user to transact using cryptocurrency with an increased predictability from the perspective of the user.

### BACKGROUND OF THE INVENTION

In recent years, numerous cryptocurrencies have been developed which allow digital currency to be transferred between cryptocurrency addresses without an intermediate financial institution or central authority. Exemplary cryptocurrency systems include peer-to-peer, decentralised implementations such as Bitcoin, Litecoin and PPCoin.

An advantage of these cryptocurrencies is that the financial infrastructure they provide may simplify and/or facilitate at least some types of transactions. However, the exchange rate of a cryptocurrency in relation to national currencies may be relatively volatile. This may discourage some users from using cryptocurrencies for day-to-day transactions.

A risk-averse user may, for example, be hesitant to purchase $100.00 worth of a cryptocurrency for fear that the value of the cryptocurrency in relation to the national currency (in this case, United States dollar) may drastically decrease and only be worth, say, $75.00, when the user wishes to spend the funds a week later.

Although there may be investors or speculators who are willing to take on risk in terms of the exchange rate volatility between a cryptocurrency and a national currency, the risk-averse user may not wish to be exposed to such volatility although he or she may wish to take advantage of the convenience or cost benefit of cryptocurrency transactions.

The present invention aims to address this problem, at least to some extent.

### SUMMARY OF THE INVENTION

In accordance with the invention there is provided a method of enabling a user to transact using cryptocurrency of a value defined in relation to a different medium of exchange or a financial instrument, comprising: receiving a request to create a voucher having a face value which remains defined in relation to the medium of exchange or the financial instrument; generating a voucher having key data included therein, the key data being associated with a voucher cryptocurrency address holding a token amount of cryptocurrency, the token amount being less than a cryptocurrency equivalent of the face value at the time the voucher is generated, wherein the key data is usable to conduct a transaction against the voucher cryptocurrency address, and wherein a record of the transaction becomes visible in a transaction ledger; monitoring the transaction ledger to determine whether a redeeming transaction against the voucher cryptocurrency address has occurred, a redeeming transaction against the voucher cryptocurrency address occurring when the token amount is transferred to a destination cryptocurrency address; and in response to a redeeming transaction against the voucher cryptocurrency address occurring, transferring an additional amount of cryptocurrency to the destination cryptocurrency address, the additional amount of cryptocurrency being calculated such that the sum of the token amount and the additional amount substantially matches a cryptocurrency equivalent of the face value of the voucher at the time of the redeeming transaction or the transferring of the additional amount.

Further features of the invention provide for the key data to include a cryptocurrency private key corresponding to a cryptocurrency public key, the voucher cryptocurrency address being represented by or derived from the cryptocurrency public key; alternatively, for the key data to include an identifier of the cryptocurrency private key which enables a user to obtain, derive or use the cryptocurrency private key.

Yet further features of the invention provide for the medium of exchange to be a national currency; for the face value to be a fixed amount of the medium of exchange; alternatively, for the face value to be defined by a formula or algorithm; for the formula or algorithm to define the face value in relation to a plurality of different mediums of exchange and/or financial instruments; and for an exchange rate between the cryptocurrency and the medium of exchange or financial instrument to be independently determined.

Still further features of the invention provide for the method to include one or both of the steps of: storing, in a database, one or both of the key data and the voucher cryptocurrency address in relation to one or both of the face value and the token amount; providing the voucher to a user such that the user is capable of using the key data or permitting another entity to use the key data to conduct a transaction against the voucher cryptocurrency address; for the voucher to be in either a physical or a digital format; and for the key data to be embedded in the voucher.

The invention extends to a wallet software application configured to be resident on an electronic device of the user. The voucher may be transmitted to the electronic device and stored thereon by way of the wallet software application.

Still further features of the invention provide for the step of monitoring the transaction ledger to determine whether a redeeming transaction against the voucher cryptocurrency address has occurred to include checking whether the destination cryptocurrency address is an authorized address, and only recognising the transferring of the token amount to the destination cryptocurrency address as a redeeming transaction if the destination cryptocurrency address is an authorized address. An authorized address may be any address that is not on a list of unauthorized addresses, the list of unauthorized addresses having been determined by a third party entity such as a regulatory body or bank. Alternatively, an authorized address may be an address which has been designated as authorized, or not designated as unauthorized.

A further feature of the invention provides for the redeeming transaction to be conducted by either of the user or a recipient entity controlling and/or managing the destination cryptocurrency address.

Further features of the invention provide for the method to include the steps of: if the destination cryptocurrency address is not an authorized address, instead of transferring the additional amount to the destination cryptocurrency address, initiating a cooling-off period; and transferring a further token amount to the voucher cryptocurrency address upon completion of the cooling-off period. If multiple transactions against non-authorized addresses occur, progressively increasing cooling-off periods may be initiated prior to transferring a further token amount to the cryptocurrency address.

Yet further features of the invention provide for the key data included in the voucher to be required in addition to further key data in order to successfully transact against the voucher cryptocurrency address; for the voucher cryptocurrency address to be a multi-signature address; for the key data included in the voucher to provide one or a partial private key, and for the further key data to provide a supplementary private key or partial private key required for transacting against the voucher cryptocurrency address. An entity in control of an authorized address may be in possession of the further key data, or the further key data may be provided to the user at a later stage.

Further features of the invention provide for the method to include the step of: receiving payment or a notification of payment in relation to the voucher; causing to be purchased cryptocurrency substantially equivalent to the value of the voucher at the time of receiving the request for the voucher or at the time of generating the voucher; alternatively, causing to be purchased cryptocurrency substantially equivalent to the value of the voucher in response to a redeeming transaction against the voucher cryptocurrency address occurring.

According to one aspect of the invention, the voucher has a plurality of face values and a plurality of corresponding token amounts are held at the voucher cryptocurrency address, each face value being associated with a particular token amount held at the voucher cryptocurrency address, and the sum of the face values constituting a total face value. In response to a redeeming transaction against the voucher cryptocurrency address occurring wherein one or more particular token amounts are transferred to a destination cryptocurrency address, an additional amount of cryptocurrency is transferred to the destination cryptocurrency address, the additional amount of cryptocurrency being calculated such that the sum of the one or more particular token amounts and the additional amount substantially matches a cryptocurrency equivalent of combined face values corresponding to the one or more particular token amounts, and the total face value is reduced by the combined face value corresponding to the one or more particular token amounts.

According to a further aspect of the invention, the voucher cryptocurrency address and key data are calculated using a deterministic seed value. The step of monitoring the transaction ledger to determine whether a redeeming transaction against the voucher cryptocurrency address has occurred may include monitoring the transaction ledger for a redeeming transaction against any cryptocurrency address calculated using the deterministic seed value.

According to an even further aspect of the invention, funds are received from a plurality of investors, each investor investing in the cryptocurrency such that the risk of a user purchasing a voucher is assumed by the investors. Each investor may agree to a leverage amount between a minimum and maximum value.

The invention extends to a system for enabling a user to transact using cryptocurrency of a value defined in relation to a different medium of exchange or a financial instrument, comprising: a request receiving component for receiving a request to create a voucher having a face value which remains defined in relation to the medium of exchange or the financial instrument; a voucher generating component for generating a voucher having key data embedded therein, the key data being associated with a voucher cryptocurrency address holding a token amount of cryptocurrency, the token amount being less than a cryptocurrency equivalent of the face value at the time the voucher is generated, wherein the key data is usable to conduct a transaction against the voucher cryptocurrency address, and wherein a record of the transaction becomes visible in a transaction ledger; a monitoring component for monitoring the transaction ledger to determine whether a redeeming transaction against the voucher cryptocurrency address has occurred, a redeeming transaction against the voucher cryptocurrency address occurring when the token amount is transferred to a destination cryptocurrency address; and a transferring component for, in response to a redeeming transaction against the voucher cryptocurrency address occurring, transferring an additional amount of cryptocurrency to the destination cryptocurrency address, the additional amount of cryptocurrency being calculated such that the sum of the token amount and the additional amount substantially matches a cryptocurrency equivalent of the face value of the voucher at the time of the redeeming transaction or the transferring of the additional amount.

The voucher may be in either a physical or a digital format, and the key data may be embedded in the voucher.

The invention extends to a computer program product for enabling a user to transact using cryptocurrency of a value defined in relation to a different medium of exchange or a financial instrument, the computer program product comprising a computer-readable medium having stored computer-readable program code for performing the steps of: receiving a request to create a voucher having a face value which remains defined in relation to the medium of exchange or the financial instrument; generating a voucher having key data included therein, the key data being associated with a voucher cryptocurrency address holding a token amount of cryptocurrency, the token amount being less than a cryptocurrency equivalent of the face value at the time the voucher is generated, wherein the key data is usable to conduct a transaction against the voucher cryptocurrency address, and wherein a record of the transaction becomes visible in a transaction ledger; monitoring the transaction ledger to determine whether a redeeming transaction against the voucher cryptocurrency address has occurred, a redeeming transaction against the voucher cryptocurrency address occurring when the token amount is transferred to a destination cryptocurrency address; and in response to a redeeming transaction against the voucher cryptocurrency address occurring, transferring an additional amount of cryptocurrency to the destination cryptocurrency address, the additional amount of cryptocurrency being calculated such that the sum of the token amount and the additional amount substantially matches a cryptocurrency equivalent of the face value of the voucher at the time of the redeeming transaction or the transferring of the additional amount.

Further features provide for the computer-readable medium to be a non-transitory computer-readable medium and for the computer-readable program code to be executable by a processing circuit.

In order for the invention to be more fully understood, implementations thereof will now be described with reference to the accompanying drawings.

### BRIEF DESCRIPTION OF THE DRAWINGS

The invention will now be described, by way of example only, with reference to the accompanying representations in which:

FIG. 1 is a schematic illustration of an embodiment of a system for enabling a user to transact using cryptocurrency according to the invention;

FIG. 2 is a swim-lane flow diagram illustrating a method of enabling a user to transact according to the invention;

FIG. 3 is a block diagram illustrating a method of enabling a user to transact according to the invention;

FIG. 4 is a schematic illustration of an embodiment of a system for enabling a user to transact using cryptocurrency according to the invention;

FIG. 5 illustrates an example of a computing device in which various aspects of the disclosure may be implemented; and,

FIG. 6 shows a block diagram of a communication device that may be used in embodiments of the disclosure.

### DETAILED DESCRIPTION WITH REFERENCE TO THE DRAWINGS

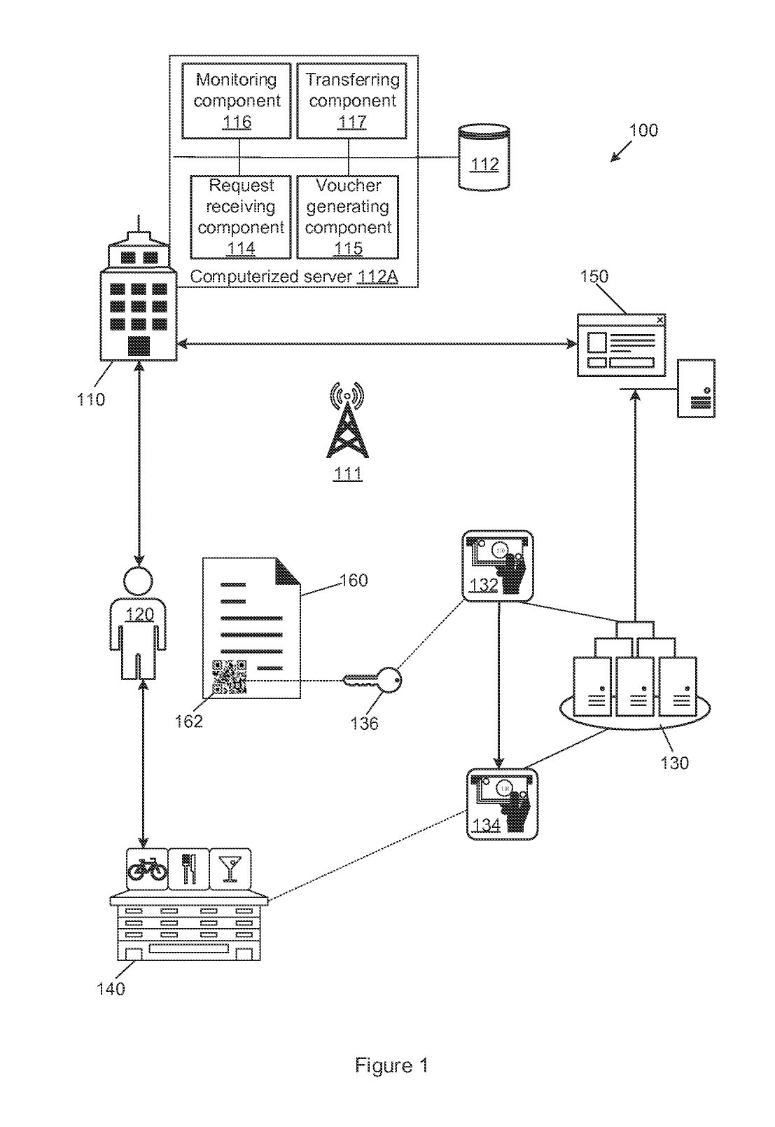

An embodiment of a system (100) for enabling a user to transact using cryptocurrency is shown in FIG. 1. The system (100) comprises an issuer (110), a user (120), a cryptocurrency system (130), and a recipient entity (140).

In this embodiment, the issuer (110) has a database (112), and a computerized server (112A) providing a request receiving component (114), a voucher generating component (115), a monitoring component (116) and a transferring component (117). The computerized server may be in communication with the cryptocurrency system (130) and/or a shared transaction ledger (150) via a communication network (111), such as the Internet.

The user (120) is capable of communicating with the issuer (110) and with the recipient entity (140) over any suitable communications channel using a device. In this embodiment, the user (120) has a wallet software application resident on an electronic device, such as a mobile communications device, with which it communicates with the issuer (110), and the recipient entity (140) is a merchant with which the user (120) physically communicates. It should be appreciated that any suitable physical, wired or wireless means of communication may be employed to permit communications between the issuer (110), the user (120) and the recipient entity (140).

The cryptocurrency system (130) allows entities to transfer digital currency from one cryptocurrency address to another cryptocurrency address without an intermediate financial institution or central authority. Exemplary cryptocurrency systems include peer-to-peer, decentralised cryptocurrencies such as Bitcoin, Litecoin and PPCoin. In this embodiment, and primarily for exemplary purposes, the cryptocurrency system (130) is Bitcoin.

Records of all transactions conducted in the cryptocurrency system (130) are held in a transaction ledger (150). In the embodiment of FIG. 1, the transaction ledger (150) is a publicly visible shared transaction ledger. Typically, the shared transaction ledger (150) includes all these transactions as a chain of transaction records or receipts, commonly referred to as a “block chain”. These transaction records are signed using both a private key and a public key, the private key being that of a party transferring value and the public key being associated with a receiving cryptocurrency address.

The shared transaction ledger (150) is typically publically accessible via a website or other Internet-based platform. In this embodiment, the issuer (110) obtains access to the transaction records described above by monitoring the transaction ledger (150).

The cryptocurrency system (130) is used to hold and transfer a balance of cryptocurrency between cryptocurrency addresses. FIG. 1 shows a voucher cryptocurrency address (132) and a destination cryptocurrency address (134), the functioning of which will be described in greater detail below. Each cryptocurrency address is represented by or derived from a cryptocurrency public key corresponding to a cryptocurrency private key. The public key is used and/or derived to obtain the cryptocurrency address, the address having a specific balance of cryptocurrency held therein. FIG. 1 shows the private key (136) corresponding to the voucher cryptocurrency address (132).

The private key (136) represents a direct monetary value which can be traded in the cryptocurrency system. In the case where the cryptocurrency is, for example, Bitcoin or another cryptocurrency system using a similar key and address scheme, a cryptocurrency address has a particular balance associated therewith, indicated, for example, as 3.5 BTC or 0.0001 BTC in the case of Bitcoin.

Transaction records are verified by third parties carrying out what is known as “mining blocks”. Exemplary cryptocurrencies which make use of proof-of-work verification schemes, such as Secure Hash Algorithm 256 (SHA-256) or scrypt, are Bitcoin and Litecoin. An exemplary cryptocurrency system employing a combined proof-of-work/proof-of-stake verification scheme is PPCoin.

The principles and functioning of such cryptocurrencies having shared transaction ledgers containing transaction records will be well understood by those skilled in the art. Notably, such a system allows a party having access to a private key or data at least partially derived therefrom to transact against a corresponding cryptocurrency address, in other words, to transfer the funds to a different address. These systems also allow parties to inspect or analyse the shared transaction ledger to determine whether a particular address was transacted against.

At any given time, the cryptocurrency has a value which can be defined in relation to other mediums of exchange or financial instruments. The cryptocurrency may have a defined value in relation to a national currency such as the United States dollar ($). For example, in the case of Bitcoin, 1.00 BTC may be equal to $450.00 at a particular point in time.

The value of a cryptocurrency may be volatile. As such, a user may, for example, be hesitant to purchase cryptocurrency for fear that its value may have drastically decreased in relation to a national currency or any other financial instrument when the user wishes to utilize the funds at a later stage.

The system (100) of FIG. 1 provides methods of enabling a user to transact using cryptocurrency of a value defined in relation to a different medium of exchange or a financial instrument, in a manner that provides an increased predictability from the perspective of the user. For exemplary purposes, United States dollar is used as the different medium of exchange throughout the description.

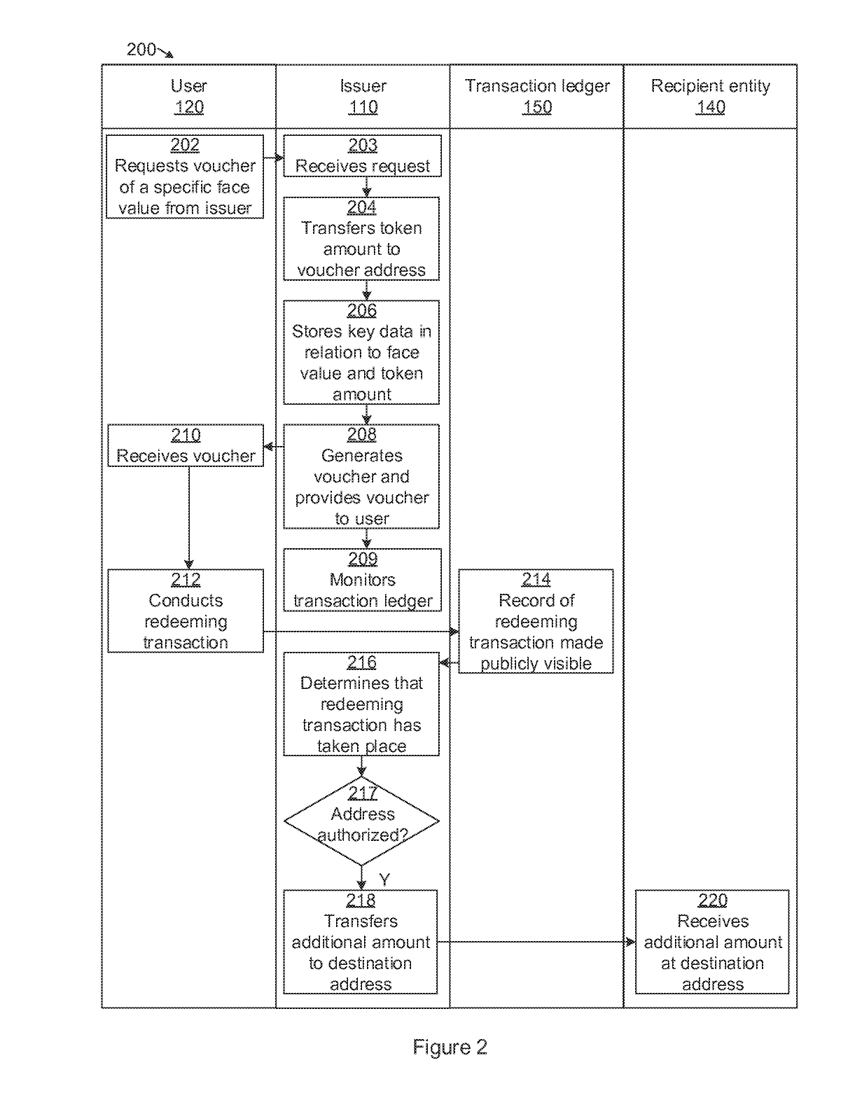

The flow diagram of FIG. 2 illustrates a first method (200) of enabling a user to transact using cryptocurrency according to the invention. The various steps may be conducted by devices maintained or operated by the respective entities. For example, the steps described below conducted by the issuer (110) may be conducted by the computerized server (112A) and various components thereof.

At a first stage (202), the user (120) requests a voucher from the issuer (110). At a following stage (203) the issuer (110) receives the request to create the voucher including a face value which is to remain defined in relation to a different medium of exchange or a financial instrument. In this example, the user (120) requests a voucher having a face value of $100.00 and the issuer (110) receives the request at the request receiving component (114).

Typically, the issuer (110) receives payment and/or a notification of payment for the voucher at this stage. The method and time of payment may vary, and any suitable method of payment may be employed. In this example, the user (120) performs a conventional electronic funds transfer transaction to transfer $100.00 to the issuer (110) so as to pay for the voucher. In some embodiments, a transaction fee may be charged by the issuer (110), for example, by requiring the user (100) to pay $102.00 for a voucher worth $100.00. The issuer (110) may also, or alternatively, charge a redemption fee when the user (120) elects to subsequently redeem the voucher.

In this example, the issuer (110) purchases the cryptocurrency equivalent of the face value of the voucher using a cryptocurrency exchange at this stage. The issuer (110) may also purchase the cryptocurrency equivalent of the value of the voucher at the time of generating the voucher, or at the time of a redeeming transaction occurring against the voucher cryptocurrency address (132), as will be described in greater detail below. Alternatively, the issuer (110) is already in possession of sufficient cryptocurrency stored at one or more cryptocurrency addresses and does not purchase or obtain more cryptocurrency.

At a next stage (204), the issuer (110) transfers a token amount of cryptocurrency to the voucher cryptocurrency address (132). The token amount is less than the cryptocurrency equivalent of the face value of the voucher at the time of generating the voucher. In other words, if $100.00 is equivalent to 0.25 BTC, the token amount is less than 0.25 BTC. The token amount is preferably a relatively small amount so as not to incentivize a party to attempt to fraudulently obtain the token amount. In this example, the token amount is 200 pBTC.

At this stage, the voucher cryptocurrency address (132) holds the token amount. At a next stage (206), the issuer (110) stores the voucher cryptocurrency address (132) and/or key data in relation to the face value and the token amount in the database (112). In this example, the key data includes the private key (136) corresponding to the cryptocurrency public key of the voucher cryptocurrency address (132). The key data may, however, include any identifier of the cryptocurrency private key or other data which enables a user to obtain, derive or use the cryptocurrency private key (136) therefrom.

At a next stage (208), the issuer (110) generates the voucher (160) and provides the generated voucher to the user. The voucher (160) includes the key data as described above, and, seeing as the private key corresponding to the cryptocurrency address (132) can be obtained therefrom, is usable to conduct a transaction against the voucher cryptocurrency address (132) and in favour of a different address. In this example, the voucher (160) is generated using the voucher generating component (115) of the issuer.

The voucher may be in either a physical or a digital format. In some embodiments, the voucher is simply the key data or private key corresponding to the voucher cryptocurrency address. In this example, the voucher (160) is a digital voucher transmitted from the issuer (110) to the wallet software application of the electronic device of the user (120), and is stored on the electronic device. The key data may be embedded in the voucher (160). In the embodiment of FIG. 1, the key data is embedded in the voucher (160) in the form of a Quick Response (QR) code (162).

The voucher is not limited to a specific format, and may be provided to the user (120) in any format as long as the user (120) is capable of using the key data or permitting another entity to use the key data to conduct a transaction against the voucher cryptocurrency address (132).

The issuer (110) uses its monitoring component (116) to monitor (209) the transaction ledger (150) so as to determine whether a redeeming transaction has occurred. In the embodiment of FIG. 1, the monitoring component (116) is used to inspect or analyse the shared transaction ledger (150), for example by using a web-based platform providing at least some of the transaction records.

The user (120) receives the voucher (160) at a next stage (210). The voucher (160) typically indicates the face value thereon, in this case $100.00, and may also include other data such as an identifier of the issuer (110). The value of the voucher (160) is thus linked to a medium of exchange or financial instrument different from the cryptocurrency, and is shielded from potential volatility in the value of the cryptocurrency.

At a next stage (212), when the user (120) wishes to redeem the voucher (160), the user (120) conducts a redeeming transaction against the voucher cryptocurrency address (132) and in favour of the destination cryptocurrency address (134).

A redeeming transaction against the voucher cryptocurrency address (132) occurs when the token amount is transferred to a destination cryptocurrency address, in this case the destination cryptocurrency address (134) of the recipient entity (140).

The user (120) may complete the redeeming transaction using its own electronic device. The user (120) may obtain the destination cryptocurrency address (134) and complete the transfer of the token amount using the electronic device. This may obviate the need to transmit key data to the recipient entity (140) and only requires the recipient entity (140) to have a cryptocurrency address. The recipient entity (140) is in control of and/or maintains the destination cryptocurrency address (134).

Alternatively, the user (120) may provide the voucher (160) or only the key data to the recipient entity (140) such that the recipient entity (140) is capable of conducting the redeeming transaction. The recipient entity (140) is typically a merchant from which the user (120) wishes to purchase goods. The user (120) may provide the voucher (160) to the recipient entity (140) by physically displaying the QR code (162) to the recipient entity (140).

Receipt of the key data, and therefore the private key (136) corresponding to the voucher cryptocurrency address (132), enables the recipient entity (140) to conduct the redeeming transaction against the voucher cryptocurrency address (132).

Completion of the redeeming transaction, whether by the user (120) or recipient entity (140), causes a record of the redeeming transaction to become visible in the transaction ledger (150) at a next stage (214).

In monitoring (209) the transaction ledger (150) so as to determine whether a redeeming transaction has occurred, the issuer (110), at a further stage (216), obtains the record of the redeeming transaction and determines that the token amount has been transferred to the destination cryptocurrency address (134). The redeeming transaction is a signal to the issuer (110) that the user (120) is exercising the option to redeem the voucher.

At a following stage (217), the issuer (110) may check whether the destination cryptocurrency address is an authorized address, and may only recognise the transferring of the token amount to the destination cryptocurrency address as a redeeming transaction if the destination cryptocurrency address is an authorized address. Authorized addresses are described in greater detail below.

In response to a redeeming transaction against the voucher cryptocurrency address (132) occurring, at a next stage (218), the issuer (110) uses its transferring component (117) to transfer an additional amount of cryptocurrency to the destination cryptocurrency address (134).

The additional amount of cryptocurrency is calculated such that the sum of the token amount and the additional amount substantially matches a cryptocurrency equivalent of the face value of the voucher at the time of the redeeming transaction or the transferring of the additional amount. Transferring of the additional amount typically occurs shortly after the redeeming transaction. At a final stage (220), the recipient entity (140) receives the additional amount of cryptocurrency at the destination address (134).

The recipient entity (140) receives the token amount and the additional amount, which together is the cryptocurrency equivalent of the face value of the voucher (160). It is envisaged that the exchange rate between the cryptocurrency and the different medium of exchange or financial instrument will be independently determined by a trusted entity.

In this way, the recipient entity (140) receives the correct amount, in other words the amount of cryptocurrency that corresponds to the face value of the voucher (160) at that time, while the user (120) is shielded from any changes in the value of the cryptocurrency in relation to the face value of the voucher.

For example, at the time of purchasing the voucher (160), the $100.00 face value of the voucher (160) may have been equivalent to 0.25 BTC, while the 0.25 BTC may only be worth $80.00 at the time of the redeeming transaction. This does not influence the user (120), as the face value of the voucher remains defined in United States dollar throughout. The risk of exchange rate loss and the potential for exchange rate gain is therefore assumed by the issuer.

In cases where the user wishes to spend less than the face value of the voucher, the user may be provided with change in the cryptocurrency, in a different medium of exchange or financial instrument, may receive credit from the recipient entity, or may receive another voucher using the method described above.

The voucher (160) or simply the key data may be provided to the recipient entity (140) in any other way. The user (120) may provide the physical or digital voucher to the recipient entity (140) for obtaining the key data, or the user (120) may transfer the token amount to the recipient entity (140) without providing the voucher (160) to the recipient entity (140). For example, the user (120) may import the key data into a digital wallet and perform a transfer to the destination address (134).

In some embodiments, the user (120) may scan a destination cryptocurrency address of the recipient entity (140) instead of the recipient entity (140) scanning the voucher cryptocurrency address of the user (120). This may be the case when the user (120) has a wallet software application resident on an electronic device. The user (120) may obtain the destination cryptocurrency address (134) and complete the transfer of the token amount using the electronic device.

In some embodiments, the token amount loaded into the voucher cryptocurrency address may be so low that it is essentially negligible. For example, the token amount may be the minimum allowable amount of Bitcoin currency, 10 nBT (also known as 1 “satoshi”). In such a case, the full face value may be paid out to the destination cryptocurrency address as the additional amount. Alternatively, the token amount may be used to cover a transaction fee or redemption fee. Alternatively, the token amount may be any fraction of the cryptocurrency equivalent of the face value.

The voucher may be in the form of a scratch-card or a sealed envelope that obscures the key data until the voucher is redeemed. In cases where the voucher is a digital voucher, the key data may be password-protected or otherwise obscured to prevent fraudulent parties from obtaining the private key. The user may store the voucher securely, such as in an encrypted format on the electronic device.

The transaction ledger (150) or “blockchain” reveals the destination cryptocurrency address (132). In some embodiments, the issuer (110) may implement measures to prevent money laundering by only allowing a user (120) to perform a redeeming transaction in favour of authorized cryptocurrency addresses.

In such a case, monitoring the transaction ledger (150) to determine whether a redeeming transaction against the voucher cryptocurrency address (132) has occurred may include checking whether the destination cryptocurrency address is an authorized address, and only recognising the transferring of the token amount to the destination cryptocurrency address as a redeeming transaction if the destination cryptocurrency address is an authorized address.

An authorized address may be any address that is not on a list of unauthorized addresses. Preferably, the list of unauthorized addresses is determined by a third party entity such as a regulatory body or bank. Alternatively, an authorized address may be an address which has been designated as authorized, or not designated as unauthorized, by the user, the issuer or by any other entity.

If the destination cryptocurrency address is not an authorized address, instead of transferring the additional amount to the destination cryptocurrency address to complete redemption of the voucher, the issuer (110) may, in some embodiments, initiate a cooling-off period. Upon completion of the cooling-off period, a further token amount may be transferred to the voucher cryptocurrency address (132). If multiple transactions against non-authorized addresses occur, this cooling-off period may be progressively increased prior to transferring a further token amount to the voucher cryptocurrency address.

Such an authorized address may be a so-called “green address”, a term used to refer to trusted cryptocurrency keypairs that indicate the origin or destination of funds. In some embodiments, the user may only be permitted to redeem the voucher at a “greenlisted” destination address.

It may be the case that a recipient party is restricted to receiving vouchers from authorized or legitimate users. In such cases, either the user or a cryptocurrency address of the user may be registered at a central authority.

It is foreseen that a recipient party may also be required to verify the identity of a user or a cryptocurrency address used by the user attempting to redeem a voucher. In such cases, the issuer may store an identifier of the user in association with details of the voucher, in order to check whether the user attempting to redeem the voucher is in fact the user that originally purchased the voucher.

It should be appreciated that the face value is not limited to being a fixed amount of the medium of exchange as described in the example above, wherein the face value is $100.00. The face value may be a financial instrument, may be defined by a formula or algorithm, and may also be defined in relation to a plurality of different mediums of exchange and/or financial instruments. The face value may therefore be dynamic.

The face value may, for example, be defined by the value of gold at a particular point in time, or by the value of a certain stock at a particular point in time, or by a formula or algorithm incorporating more than one of the examples above or other mediums of exchange or financial instruments. In other embodiments, the face value may even be unpredictable and/or initially undetermined, and only determined or defined at a later stage by way of a random allocation such as in the case of a lottery. Other methods of determining a face value which is linked to a value (or hoped-for value) extrinsic to the cryptocurrency also fall within the scope of the invention.

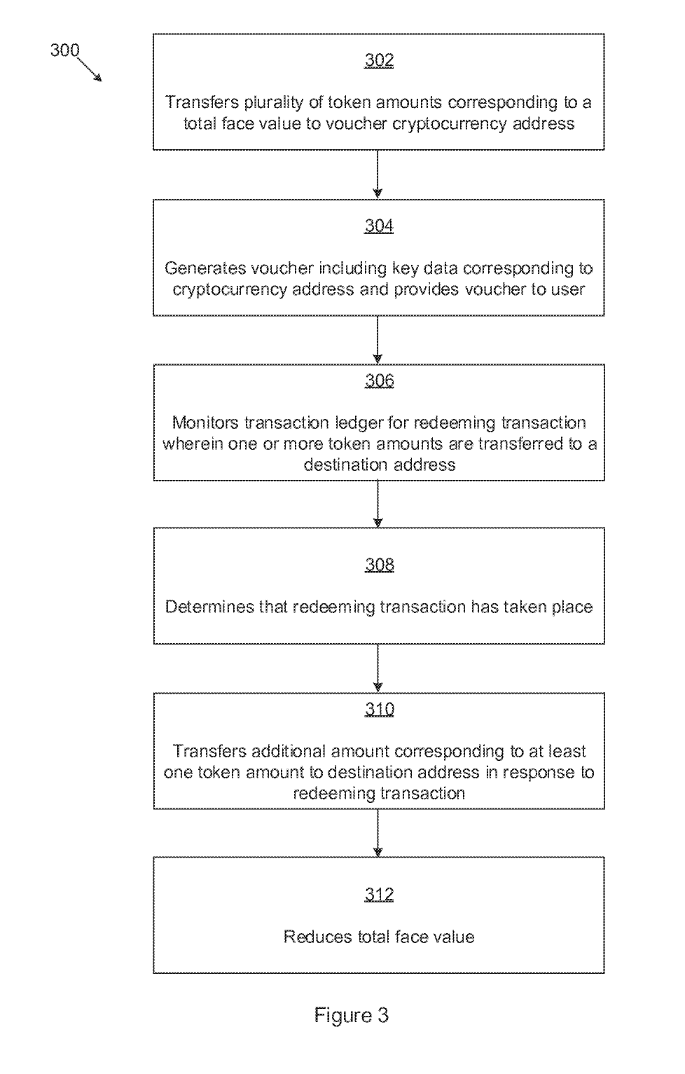

The block diagram of FIG. 3 illustrates a further method (300) of enabling a user to transact using cryptocurrency according to the invention. In this embodiment of the invention, a wallet software application of the user is loaded with a voucher which has a total face value consisting of a plurality of smaller face values, each face value being associated with a token amount. This implementation of the invention permits the user to redeem a voucher at a plurality of different destination addresses, or to reuse the voucher at a particular destination address.

The wallet application may, for example, be resident on a mobile phone and/or personal computer of the user. In this embodiment, each token amount represents one unit of the medium of exchange or financial instrument in which the voucher is issued. In this example, the token amount is 100 nBTC, which represents $1.00.

At a first stage (302), in response to the user (120) requesting, for example, a voucher having a face value of $1000.00, the issuer (110) transfers a plurality of token amounts to the voucher cryptocurrency address (132), each of the token amounts corresponding to a face value such that the sum of the face values is equal to the total face value.

For example, if the token amount is 100 nBT representing $1.00, an amount equal to 1000 tokens of 100 nBTC is transferred to the voucher cryptocurrency address (132). A total of 0.0001 BTC is thus transferred to the voucher cryptocurrency address (132), representing the total face value of $1000.00. An additional amount may be transferred to account for certain fees, such as transaction fees or redemption fees.

At a next stage (304), the issuer (110) generates the voucher (160) which includes the key data corresponding to the voucher cryptocurrency address (132) and provides the voucher (160) to the user (120). Typically, the voucher cryptocurrency address (132) and/or key data is stored in relation to the total face value.

The user (120) may, in this embodiment, make use of a wallet software application as described above. The voucher may be loaded into the application, and the application provides the user (120) with information such as a current total face value of the voucher, and may enable the user (120) to transact using some or all of the value of the voucher.

The issuer (110) then, at a further stage (306), commences to monitor the transaction ledger (150) to determine whether a redeeming transaction has occurred against the voucher cryptocurrency address (132). A redeeming transaction is, in this embodiment, any transaction in which one or more of the token amounts are transferred to a destination address.

At a next stage (308), the issuer (110) inspects the transaction ledger (150) and determines that a redeeming transaction has taken place in favour of the destination cryptocurrency address (132) of the recipient entity (140). In this example, the amount transferred to the destination cryptocurrency address (132) represents the United States dollar equivalent in cryptocurrency that must be transferred to the recipient entity (140).

It may, for example, be the case that a token amount of 1000 nBT is transferred to the destination cryptocurrency address (132). This amount represents $10.00, and the issuer (110) calculates the additional amount to be transferred to the destination cryptocurrency address (132) such that the sum of the one or more particular token amounts making up the 1000 nBT and the additional amount substantially matches a cryptocurrency equivalent of the combined face values corresponding to the one or more particular token amounts. The additional amount together with the 1000 nBT matches the cryptocurrency equivalent of the $10.00 at time of the redeeming transaction.

At a next stage (310), the issuer (110) transfers the additional amount to the destination cryptographic address (134). At a final stage, the total face value is reduced by the combined face value corresponding to the one or more particular token amounts. In this example, the total face value is reduced from $1000.00 to $990.00. The total face value may be updated in the database (112) and also in the wallet software application so as to keep track of funds available to the user (120).

This method enables a user to reuse a voucher and/or to redeem portions of the total face value of the voucher at different recipient entities. It is foreseen that the user may load further funds onto the wallet so as to increase the total face value thereof.

To enhance security and/or privacy of a user, the voucher cryptocurrency address and key data may be calculated using a deterministic seed value. In such a case, monitoring of the transaction ledger to determine whether a redeeming transaction against the voucher cryptocurrency address has occurred may include monitoring the transaction ledger for a redeeming transaction against any cryptocurrency address which has been calculated using the deterministic seed value. This may be preferable in cases where it is undesirable to reuse a cryptocurrency address.

To implement a seed value configuration, a master private key and master public key may be associated with a user. Private keys are derived from the master private key, and are usable to sign transactions associated with a corresponding public key (voucher cryptocurrency address) which is derived from the master public key. The master private key may be used to sign transactions associated with multiple public keys or cryptocurrency addresses, wherein such addresses are derived from the master public key.

Furthermore, the key data included in the voucher may in some cases not by itself enable the user to transact against the voucher cryptocurrency address. Further key data may be required in addition to the key data in order to successfully transact against the voucher cryptocurrency address. In such cases, the voucher cryptocurrency address may be a multi-signature address.

Alternatively, the key data included in the voucher may provide one or a partial private key, and the further key data may then provide a supplementary private key or partial private key required for transacting against the voucher cryptocurrency address. The issuer or an entity in control of an authorized address may be in possession of the further key data, or the further key data may be provided to the user at a later stage in any suitable manner.

The present invention thus allows a user to purchase a voucher from an issuer, which may be a financial institution such as a bank, at a set amount. The voucher has a face value which from the outset remains defined in relation to a different medium of exchange or financial instrument, an underlying cryptocurrency, and an independently determined exchange rate between the face value and the cryptocurrency. Implementation of the invention may be advantageous in that it provides a relatively simple method of purchasing and transacting with cryptocurrency, while also increasing predictability from the side of the user.

In the embodiment of the invention described with reference to FIG. 1, the risk of exchange rate loss and the potential for exchange rate gain is assumed by the issuer. The voucher obtained by the user remains defined in relation to a different medium of exchange or financial instrument, instead of being defined as the value of the cryptocurrency, in order to provide the user with a voucher which potentially has a more predictable value.

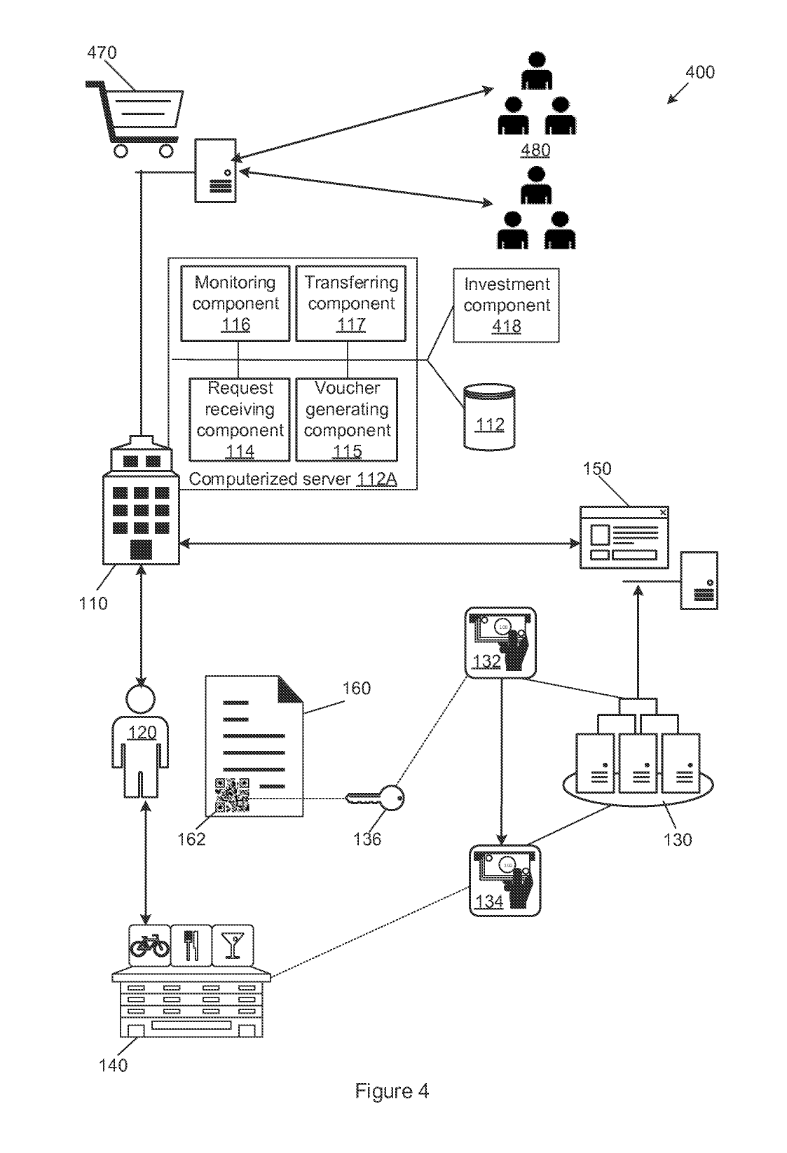

A further embodiment of a system (400) for enabling a user to transact using cryptocurrency is illustrated in FIG. 4. The system (400) of FIG. 4 is similar to the system (100) of FIG. 1, and like reference numerals refer to like components and entities.

In this embodiment, the system (400) further includes an investment tool (470) whereby the issuer (110) of the voucher receives funds from a plurality of investors (480). The investment tool (470) may be provided by a secure website by means of which investors may invest in the particular cryptocurrency of the cryptocurrency system (130).

The issuer (110) receives and pays out funds using an investment component (418). This configuration allows the issuer (110) to have investors at least partially assume the risk of a user purchasing a voucher, and may also provide the issuer (110) with funds required to transfer token amounts to voucher cryptocurrency addresses and additional amounts to destination cryptocurrency addresses.

If the value of the cryptocurrency increases, an investor may gain funds, while the investor may lose funds if the value of the cryptocurrency decreases.

In one embodiment, the system (400) comprises a plurality of users and a plurality of investors and essentially stabilises the funds of a user by employing a user pool and an investor pool. The investors (480) are required to invest in an amount of cryptocurrency substantially matching the user pool, which consists of the combined value of their vouchers. Each investor may agree to a leverage amount between a minimum and maximum value.

Funds from the investor pool may then be used to top up the user pool in cases where the value of the cryptocurrency decreases. In cases where the value of the cryptocurrency increases, returns may be paid from the user pool into accounts of the investors using the investment component (418). This ensures that the funds associated with a voucher of a user remain substantially stable and protects users from potential volatility of a cryptocurrency.

The above description of embodiments of the invention is done by way of example only and it should be appreciated that numerous changes and modifications may be made to the embodiments described without departing from the scope of the invention. The voucher may, for example, have a limited period of validity. In such cases, the voucher may include an expiry date.

In an exemplary cryptocurrency system, Bitcoin, the cryptocurrency address is a 160-bit hash of the public portion of a public/private Elliptic Curve Digital Signature Algorithm (ECDSA) keypair. In at least one known cryptocurrency system, the cryptocurrency address is therefore algorithmically converted from a public key. However, it should be appreciated that the cryptocurrency address may be the public key itself, or any other identifier derived at least partially from the public key. The cryptocurrency address and public key may thus comprise different values or strings of characters that are uniquely associated with each other such that the private key remains unambiguously linked to the cryptocurrency address. The invention is not limited to one or more particular cryptocurrency systems, as will be apparent to those skilled in the art.

It should be noted that, throughout the entirety of this specification, wherever the terms “private key,” “key data”, “public key”, “cryptocurrency address”, or the like is used, the term may, of course, refer to any derivation thereof that can be used to reliably obtain the identifier or data signified by the term used. Such a derivation of the private key, for example a cryptographic hash thereof, may therefore be embedded in the token. Importantly, the key data embedded in the token includes the cryptocurrency private key or an address identifier derived at least partially from the cryptocurrency private key. For example, the address identifier may be a link, a tool or any other identifier usable to obtain or access the private key.

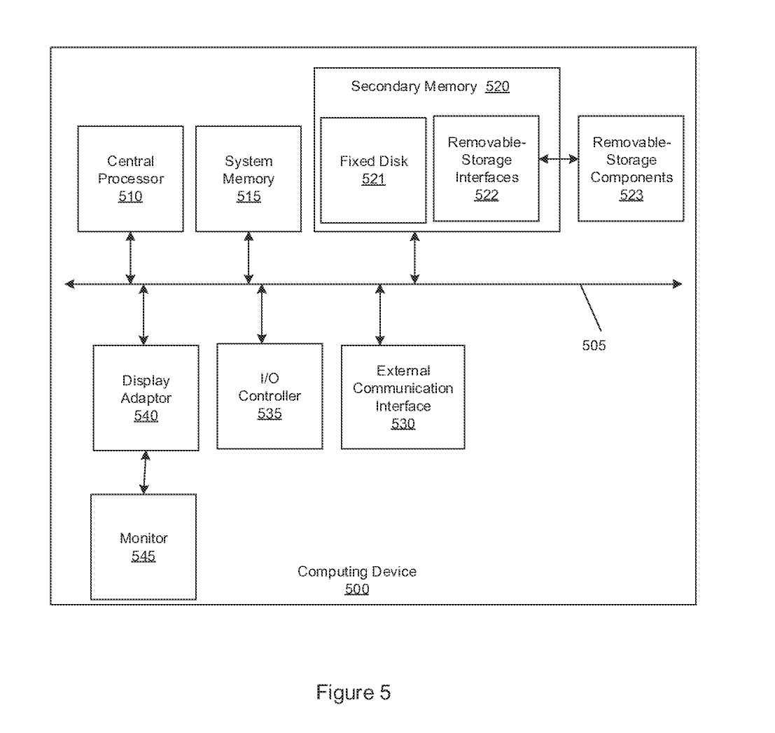

FIG. 5 illustrates an example of a computing device (500) in which various aspects of the disclosure may be implemented. The computing device (500) may be suitable for storing and executing computer program code. The various participants and elements in the previously described system diagrams may use any suitable number of subsystems or components of the computing device (500) to facilitate the functions described herein.

The computing device (500) may include subsystems or components interconnected via a communication infrastructure (505) (for example, a communications bus, a cross-over bar device, or a network). The computing device (500) may include at least one central processor (510) and at least one memory component in the form of computer-readable media.

The memory components may include system memory (515), which may include read only memory (ROM) and random access memory (RAM). A basic input/output system (BIOS) may be stored in ROM. System software may be stored in the system memory (515) including operating system software.

The memory components may also include secondary memory (520). The secondary memory (520) may include a fixed disk (521), such as a hard disk drive, and, optionally, one or more removable-storage interfaces (522) for removable-storage components (523).

The removable-storage interfaces (522) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (522) may also be in the form of ports or sockets for interfacing with other forms of removable-storage components (523) such as a flash memory drive, external hard drive, or removable memory chip, etc.

The computing device (500) may include an external communications interface (530) for operation of the computing device (500) in a networked environment enabling transfer of data between multiple computing devices (500). Data transferred via the external communications interface (530) may be in the form of signals, which may be electronic, electromagnetic, optical, radio, or other types of signal.

The external communications interface (530) may enable communication of data between the computing device (500) and other computing devices including servers and external storage facilities. Web services may be accessible by the computing device (500) via the communications interface (530).

The external communications interface (530) may also enable other forms of communication to and from the computing device (500) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (510). A computer program product may be provided by a non-transient computer-readable medium, or may be provided via a signal or other transient means via the communications interface (530).

Interconnection via the communication infrastructure (505) allows a central processor (510) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, or the like) may couple to the computing device (500) either directly or via an I/O controller (535). These components may be connected to the computing device (500) by any number of means known in the art, such as a serial port. One or more monitors (545) may be coupled via a display or video adapter (540) to the computing device (500).

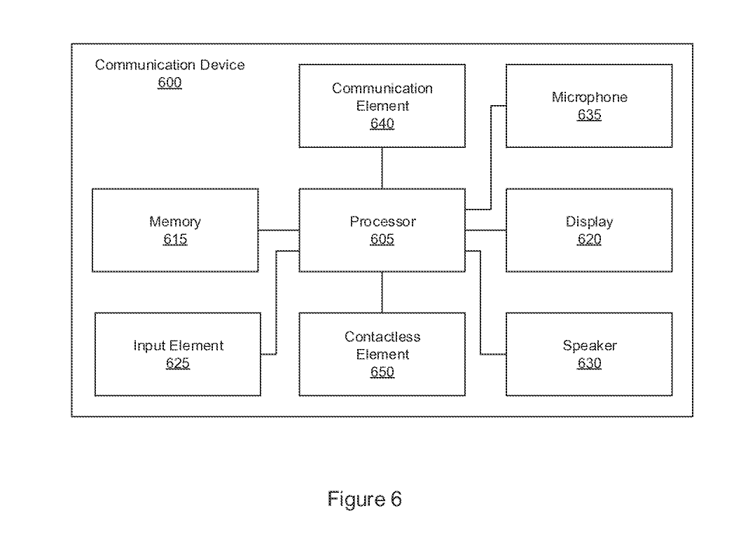

FIG. 6 shows a block diagram of a communication device (600) that may be used in embodiments of the disclosure. The communication device (600) may be a cell phone, a feature phone, a smart phone, a satellite phone, or a computing device having a phone capability.

The communication device (600) may include a processor (605) (e.g., a microprocessor) for processing the functions of the communication device (600) and a display (620) to allow a user to see the phone numbers and other information and messages. The communication device (600) may further include an input element (625) to allow a user to input information into the device (e.g., input buttons, touch screen, etc.), a speaker (630) to allow the user to hear voice communication, music, etc., and a microphone (635) to allow the user to transmit his or her voice through the communication device (600). The processor (610) of the communication device (600) may connect to a memory (615). The memory (615) may be in the form of a computer-readable medium that stores data and, optionally, computer-executable instructions.

The communication device (600) may also include a communication element (640) for connection to communication channels (e.g., a cellular telephone network, data transmission network, Wi-Fi network, satellite-phone network, Internet network, Satellite Internet Network, etc.). The communication element (640) may include an associated wireless transfer element, such as an antenna.

The communication element (640) may include a subscriber identity module (SIM) in the form of an integrated circuit that stores an international mobile subscriber identity and the related key used to identify and authenticate a subscriber using the communication device (600). One or more subscriber identity modules may be removable from the communication device (600) or embedded in the communication device (600).

The communication device (600) may further include a contactless element (650), which is typically implemented in the form of a semiconductor chip (or other data storage element) with an associated wireless transfer element, such as an antenna. The contactless element (650) may be associated with (e.g., embedded within) the communication device (600) and data or control instructions transmitted via a cellular network may be applied to the contactless element (650) by means of a contactless element interface (not shown). The contactless element interface may function to permit the exchange of data and/or control instructions between mobile device circuitry (and hence the cellular network) and the contactless element (650).

The contactless element (650) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the communication device (600) and an interrogation device. Thus, the communication device (600) may be capable of communicating and transferring data and/or control instructions via both a cellular network and near field communications capability.

The communication device (600) may be, amongst other things, a notification device that can receive alert messages and access reports, a portable merchant device that can be used to transmit control data identifying a discount to be applied, as well as a portable consumer device that can be used to make payments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A method of enabling a user to transact using cryptocurrency of a value defined in relation to a different medium of exchange or a financial instrument, comprising:
receiving a request to create a voucher having a face value which remains defined in relation to the medium of exchange or the financial instrument;
generating a voucher having key data included therein, the key data being associated with a voucher cryptocurrency address holding a token amount of cryptocurrency, the token amount being less than a cryptocurrency equivalent of the face value at the time the voucher is generated, wherein the key data is usable to conduct a transaction against the voucher cryptocurrency address, and wherein a record of the transaction becomes visible in a transaction ledger;
monitoring the transaction ledger to determine whether a redeeming transaction against the voucher cryptocurrency address has occurred, a redeeming transaction against the voucher cryptocurrency address occurring when the token amount is transferred to a destination cryptocurrency address; and
in response to a redeeming transaction against the voucher cryptocurrency address occurring, transferring an additional amount of cryptocurrency to the destination cryptocurrency address, the additional amount of cryptocurrency being calculated such that the sum of the token amount and the additional amount substantially matches a cryptocurrency equivalent of the face value of the voucher at the time of the redeeming transaction or the transferring of the additional amount.

2. The method as claimed in claim 1, wherein the key data includes a cryptocurrency private key corresponding to a cryptocurrency public key, the voucher cryptocurrency address being represented by or derived from the cryptocurrency public key.

3. The method as claimed in claim 1, wherein the key data includes an identifier of a cryptocurrency private key which enables a user to obtain, derive or use the cryptocurrency private key.

4. The method as claimed in claim 1, wherein the medium of exchange is a national currency, and wherein the face value is either a fixed amount of the medium of exchange, or the face value is defined by a formula or algorithm.

5. The method as claimed in claim 4, wherein the formula or algorithm defines the face value in relation to a plurality of different mediums of exchange and/or financial instruments.

6. The method as claimed in claim 1, wherein an exchange rate between the cryptocurrency and the medium of exchange or financial instrument is independently determined.

7. The method as claimed in claim 1, wherein the method includes one or both of the steps of:
storing, in a database, one or both of the key data and the voucher cryptocurrency address in relation to one or both of the face value and the token amount;
providing the voucher to a user such that the user is capable of using the key data or permitting another entity to use the key data to conduct a transaction against the voucher cryptocurrency address.

8. The method as claimed in claim 1, wherein the step of monitoring the transaction ledger to determine whether a redeeming transaction against the voucher cryptocurrency address has occurred includes checking whether the destination cryptocurrency address is an authorized address, and only recognizing the transferring of the token amount to the destination cryptocurrency address as a redeeming transaction if the destination cryptocurrency address is an authorized address.

9. The method as claimed in claim 8, wherein an authorized address is any address that is not on a list of unauthorized addresses, the list of unauthorized addresses having been determined by a third party entity.

10. The method as claimed in claim 8, wherein an authorized address is one of: an address which has been designated as authorized, or an address which has not been designated as unauthorized.

11. The method as claimed in claim 1, wherein the redeeming transaction is conducted by either the user or a recipient entity controlling and/or managing the destination cryptocurrency address.

12. The method as claimed in claim 8, wherein the method includes the steps of:
if the destination cryptocurrency address is not an authorized address, instead of transferring the additional amount to the destination cryptocurrency address, initiating a cooling-off period; and
transferring a further token amount to the voucher cryptocurrency address upon completion of the cooling-off period.

13. The method as claimed in claim 12, wherein, if multiple transactions against non-authorized addresses occur, the method includes a step of initiating progressively increasing cooling-off periods prior to transferring a further token amount to the cryptocurrency address.

14. The method as claimed in claim 1, wherein the method includes the steps of:
receiving payment or a notification of payment in relation to the voucher;
either causing to be purchased cryptocurrency substantially equivalent to the value of the voucher at the time of receiving the request for the voucher or at the time of generating the voucher, or causing to be purchased cryptocurrency substantially equivalent to the value of the voucher in response to a redeeming transaction against the voucher cryptocurrency address occurring.

15. The method as claimed in claim 1, wherein the voucher has a plurality of face values and a plurality of corresponding token amounts are held at the voucher cryptocurrency address, each face value being associated with a particular token amount held at the voucher cryptocurrency address, and the sum of the face values constituting a total face value.

16. The method as claimed in claim 15, wherein in response to a redeeming transaction against the voucher cryptocurrency address occurring wherein one or more particular token amounts are transferred to a destination cryptocurrency address, an additional amount of cryptocurrency is transferred to the destination cryptocurrency address, the additional amount of cryptocurrency being calculated such that the sum of the one or more particular token amounts and the additional amount substantially matches a cryptocurrency equivalent of combined face values corresponding to the one or more particular token amounts, and the total face value is reduced by the combined face value corresponding to the one or more particular token amounts.

17. The method as claimed in claim 1, wherein the voucher cryptocurrency address and key data are calculated using a deterministic seed value and wherein the step of monitoring the transaction ledger to determine whether a redeeming transaction against the voucher cryptocurrency address has occurred includes monitoring the transaction ledger for a redeeming transaction against any cryptocurrency address calculated using the deterministic seed value.

18. A system for enabling a user to transact using cryptocurrency of a value defined in relation to a different medium of exchange or a financial instrument, comprising:
a request receiving component for receiving a request to create a voucher having a face value which remains defined in relation to the medium of exchange or the financial instrument;
a voucher generating component for generating a voucher having key data embedded therein, the key data being associated with a voucher cryptocurrency address holding a token amount of cryptocurrency, the token amount being less than a cryptocurrency equivalent of the face value at the time the voucher is generated, wherein the key data is usable to conduct a transaction against the voucher cryptocurrency address, and wherein a record of the transaction becomes visible in a transaction ledger;
a monitoring component for monitoring the transaction ledger to determine whether a redeeming transaction against the voucher cryptocurrency address has occurred, a redeeming transaction against the voucher cryptocurrency address occurring when the token amount is transferred to a destination cryptocurrency address; and
a transferring component for, in response to a redeeming transaction against the voucher cryptocurrency address occurring, transferring an additional amount of cryptocurrency to the destination cryptocurrency address, the additional amount of cryptocurrency being calculated such that the sum of the token amount and the additional amount substantially matches a cryptocurrency equivalent of the face value of the voucher at the time of the redeeming transaction or the transferring of the additional amount.

19. The system as claimed in claim 18, wherein the voucher is in either a physical or a digital format, and wherein the key data is embedded in the voucher.

20. A computer program product for enabling a user to transact using cryptocurrency of a value defined in relation to a different medium of exchange or a financial instrument, the computer program product comprising a computer-readable medium having stored computer-readable program code for performing the steps of:
receiving a request to create a voucher having a face value which remains defined in relation to the medium of exchange or the financial instrument;
generating a voucher having key data included therein, the key data being associated with a voucher cryptocurrency address holding a token amount of cryptocurrency, the token amount being less than a cryptocurrency equivalent of the face value at the time the voucher is generated, wherein the key data is usable to conduct a transaction against the voucher cryptocurrency address, and wherein a record of the transaction becomes visible in a transaction ledger;
monitoring the transaction ledger to determine whether a redeeming transaction against the voucher cryptocurrency address has occurred, a redeeming transaction against the voucher cryptocurrency address occurring when the token amount is transferred to a destination cryptocurrency address; and
in response to a redeeming transaction against the voucher cryptocurrency address occurring, transferring an additional amount of cryptocurrency to the destination cryptocurrency address, the additional amount of cryptocurrency being calculated such that the sum of the token amount and the additional amount substantially matches a cryptocurrency equivalent of the face value of the voucher at the time of the redeeming transaction or the transferring of the additional amount.
